(19) United States
(12) Patent Application Publication
(10) Pub. No.: US 2016/0111205 A1
(43) Pub. Date: Apr. 21, 2016

(54) CHIP COMPONENT AND MANUFACTURING METHOD THEREOF

(71) Applicant: SAMSUNG ELECTRO-MECHANICS CO., LTD., Suwon-si (KR)

(72) Inventor: Bong Sup LIM, Suwon-Si (KR)

(21) Appl. No.: 14/675,005

(22) Filed: Mar. 31, 2015

(30) Foreign Application Priority Data
Oct. 15, 2014 (KR) 10-2014-0139246

(51) Int. Cl. H01F 27/29; H01F 41/04; H01F 41/10; H01F 27/28

(52) U.S. Cl. CPC H01F 27/292; H01F 27/2804; H01F 41/041; H01F 41/10; H01F 2027/2809

(57) ABSTRACT

There are provided a chip component and a manufacturing method thereof. The chip component according to an exemplary embodiment of the present disclosure includes: a multilayer body including a plurality of insulating layers and having a bottom surface provided as a mounting surface and a top surface opposing the bottom surface; first external electrodes disposed on the bottom surface of the multilayer body; and second external electrodes disposed on both end surfaces of the multilayer body in a length direction of the multilayer body and the bottom surface of the multilayer body, wherein the second external electrodes are disposed to cover at least portions of the first external electrodes.

### CROSS-REFERENCE TO RELATED APPLICATION

This application claims the priority and benefit of Korean Patent Application No. 10-2014-0139246 filed on Oct. 15, 2014, with the Korean Intellectual Property Office, the disclosure of which is incorporated herein by reference.

### BACKGROUND

The present disclosure relates to a chip component and a manufacturing method thereof.

An inductor, a chip component, is a representative passive element forming an electronic circuit together with a resistor and a capacitor to remove noise therefrom, and is combined with the capacitor to configure a resonance circuit amplifying a signal in a specific frequency band, a filter circuit, or the like.

As miniaturization and thinning of information technology (IT) devices such as communications devices, display devices, and the like, have accelerated, research into technology for miniaturizing and thinning various elements such as inductors, capacitors, transistors, and the like, used in these IT devices, has been continuously conducted.

Inductors have also been rapidly replaced by small, high density chips able to be automatically surface-mounted, and thin film type inductors, in which a mixture of a magnetic powder and a resin is provided as coil patterns formed by plating upper and lower surfaces of a thin film insulating substrate, and multilayer inductors, in which internal conductive patterns are printed on a magnetic body and a series of processes such as a via hole punching step, a stacking step, a sintering step, and the like are performed, have been continuously developed.

Since multilayer inductors demonstrate predominant reactance components in a low frequency region, such inductors are operated as inductors reflecting noise, but in the case in which the frequency is increased, such inductors may be operated as resistors converting noise into heat and absorbing the heat generated thereby. Therefore, when a multilayer inductor is operated as a resistor, due to an increase in resistance components in a high frequency region, such a multilayer inductor is also known as a multilayer bead.

In case of multilayer inductors, deterioration of inductance L and quality factor Q characteristics may occur due to eddy currents . In addition, in the case in which chips are mounted on a substrate, defects may frequently occur due to chip toppling.

### RELATED ART DOCUMENT

(Patent Document 1) Japanese Patent Laid-Open Publication No. 2006-0032430

### SUMMARY

An aspect of the present disclosure may provide a chip component in which first external electrodes may be formed on a bottom surface of a multilayer body using a printing process while second external electrodes may be formed on the bottom surface of the multilayer body and both end surfaces thereof in a length direction using a dipping process.

An aspect of the present disclosure may provide a chip component and a manufacturing method capable of preventing deteriorations in inductance L and Q characteristics due to eddy currents though disposing internal electrodes in a multilayer body to be adjacent to a top surface of the multilayer body and improving fixing strength by forming external electrode portions on the top and bottom surfaces of the multilayer body to have different widths.

According to an aspect of the present disclosure, a chip component may include: a multilayer body including a plurality of insulating layers and having a bottom surface provided as a mounting surface and a top surface opposing the bottom surface; first external electrodes disposed on the bottom surface of the multilayer body; and second external electrodes disposed on both end surfaces of the multilayer body in a length direction and the bottom surface of the multilayer body, wherein the second external electrodes are disposed to cover at least portions of the first external electrodes.

According to another aspect of the present disclosure, a chip component may include: a multilayer body including a plurality of insulating layers and having a bottom surface provided as a mounting surface and a top surface opposing the bottom surface; internal electrodes having internal conductor patterns disposed on the plurality of insulating layers; first external electrodes disposed on the bottom surface of the multilayer body; and second external electrodes disposed on both end surfaces of the multilayer body in a length direction and the bottom surface of the multilayer body and connected to the internal electrodes; and step portions formed by disposing the second external electrodes on at least portions of the first external electrodes.

According to another aspect of the present disclosure, a method of manufacturing a chip component may include: preparing a plurality of insulating layers; forming internal conductor patterns on the plurality of insulating layers; forming a multilayer body including internal electrodes by stacking the plurality of insulating layers on which the internal conductor patterns are formed; forming first external electrodes on a bottom surface provided as a mounting surface of the multilayer body using a printing process; and forming second external electrodes on both end surfaces of the multilayer body in a length direction thereof using a dipping process, wherein the second external electrodes are disposed to cover at least portions of the first external electrodes.

### BRIEF DESCRIPTION OF DRAWINGS

The above and other aspects, features and advantages of the present disclosure will be more clearly understood from the following detailed description taken in conjunction with the accompanying drawings, in which:

FIG. 1 is a perspective view of a chip component according to an exemplary embodiment of the present disclosure;

FIG. 2 is a perspective view partially showing an inner portion of a chip component according to an exemplary embodiment of the present disclosure;

FIG. 3 is a cross-sectional view of the chip component shown in FIG. 1 taken along line A-A′;

FIG. 4 is a view showing internal electrodes in the chip component according to an exemplary embodiment of the present disclosure;

FIG. 5 is a perspective view showing a marking pattern in the chip component shown in FIG. 1;

FIG. 6 is a comparison graph showing Q characteristics of the chip component according to an exemplary embodiment of the present disclosure;

FIG. 7 is a view showing a bottom surface of the chip component according to an exemplary embodiment of the present disclosure; and

FIG. 8 is a flowchart illustrating a method of manufacturing a chip component according to an exemplary embodiment of the present disclosure.

### DETAILED DESCRIPTION

Exemplary embodiments of the present disclosure will now be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements maybe exaggerated for clarity, and the same reference numerals will be used throughout to designate the same or like elements.

### Chip Component

Hereinafter, a chip component according to an exemplary embodiment of the present disclosure, particularly, a multilayer inductor will be described. However, the present disclosure is not limited thereto.

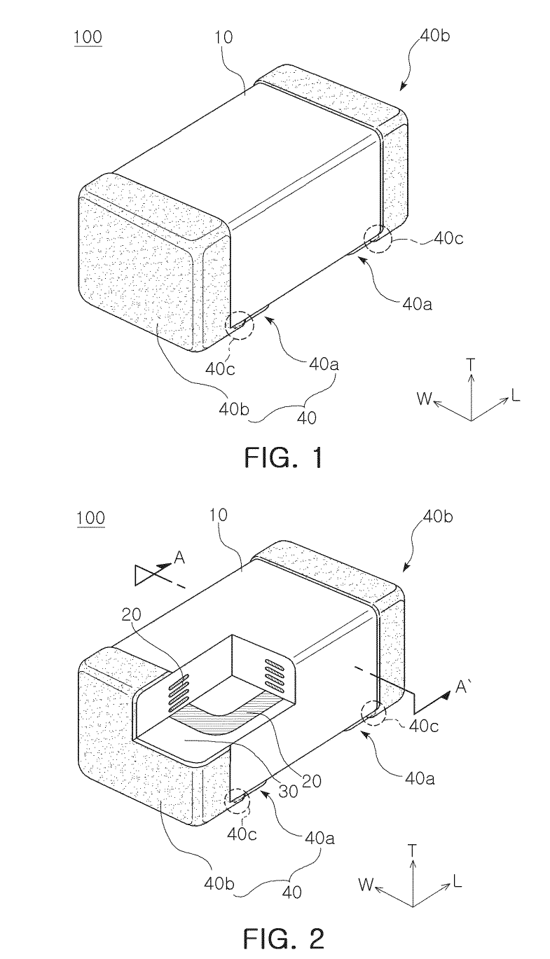

FIG. 1 is a perspective view of a chip component according to an exemplary embodiment of the present disclosure.

Referring to FIG. 1, the chip component according to an exemplary embodiment of the present disclosure may include a multilayer body 10, first external electrodes 40a, and second external electrodes 40b.

The multilayer body 10 may be formed by stacking a plurality of insulating layers. The multilayer body 10 may be in a state in which the plurality of insulating layers are sintered. The plurality of insulating layers may be integrated with each other so that a boundary between adjacent insulating layers is not readily apparent without using a scanning electron microscope (SEM).

Each of the plurality of insulating layers may include ferrite known in the art such as Mn—Zn based ferrite, Ni—Zn based ferrite, Ni—Zn—Cu based ferrite, Mn—Mg based ferrite, Ba based ferrite, Li based ferrite, or the like.

Directions of the multilayer body 10 will be defined in order to clearly describe an exemplary embodiment of the present disclosure. L, W and T shown in FIG. 1 refer to a length direction, a width direction, and a thickness direction, respectively. In addition, the multilayer body 10 may have a bottom surface provided as a mounting surface, a top surface opposing the bottom surface, two end surfaces in a length direction, and two side surfaces in a width direction.

Here, the ‘thickness direction’ refers to a direction in which the plurality of insulating layers are stacked, that is, a ‘stacked direction’.

The first external electrode 40a may be disposed on the bottom surface of the multilayer body 10. On the contrary, the second external electrodes 40b may be disposed on both end surfaces of the multilayer body 10 and the bottom surface of the multilayer body 10.

In this case, the second external electrodes 40b may be formed to cover at least portions of the first external electrodes 40a.

More specifically, firstly, the first external electrodes 40a may be formed on the bottom surface of the multilayer body 10 using a printing process. Next, secondarily, the second external electrodes 40b may be formed on the end surfaces of the multilayer body 10 and the bottom surface thereof using a dipping process.

That is, the second external electrodes 40b may be formed to cover at least portions of the first external electrodes 40a which are pre-formed on the bottom surface of the multilayer body 10. Therefore, the chip component according to the present disclosure may further include step portions 40c formed in regions in which the second external electrodes 40b cover at least portions of the first external electrodes 40a, on the bottom surface of the multilayer body 10. The step portions may have a height of 10 to 30 μm in a thickness direction of the multilayer body.

In addition, the second external electrodes 40b may be formed to be extended from both end surfaces of the multilayer body 10 to the top surface of the multilayer body 10. Further, the second external electrodes 40b may be formed to be extended from both end surfaces of the multilayer body 10 to both side surfaces of the multilayer body 10.

The first and second external electrodes 40a and 40b may be formed by printing a conductive paste containing a conductive metal. The conductive metal is not particularly limited as long as it is a metal having excellent electrical conductivity. For example, the conductive metal may be one of silver (Ag), palladium (Pd), aluminum (Al), nickel (Ni), titanium (Ti), gold (Au), copper (Cu), platinum (Pt), and the like, or a mixture thereof.

FIG. 2 is a perspective view partially showing an inner portion of a chip component according to an exemplary embodiment of the present disclosure.

Referring to FIG. 2, the chip component according to an exemplary embodiment of the present disclosure may further include internal electrodes 20 having internal conductor patterns disposed on a plurality of insulating layers 30.

The internal electrodes 20 may be formed by electrically connecting the internal conductor patterns disposed on the plurality of insulating layers 30 by via electrodes (not shown). In this case, the via electrodes may be formed by a punching to connect upper and lower insulating layers 30 to each other.

The internal electrodes 20 may be formed by printing a conductive paste containing a conductive metal. The conductive metal is not particularly limited as long as it is a metal having excellent electrical conductivity. For example, the conductive metal may be one of silver (Ag), palladium (Pd), aluminum (Al), nickel (Ni), titanium (Ti), gold (Au), copper (Cu), platinum (Pt), and the like, or a mixture thereof.

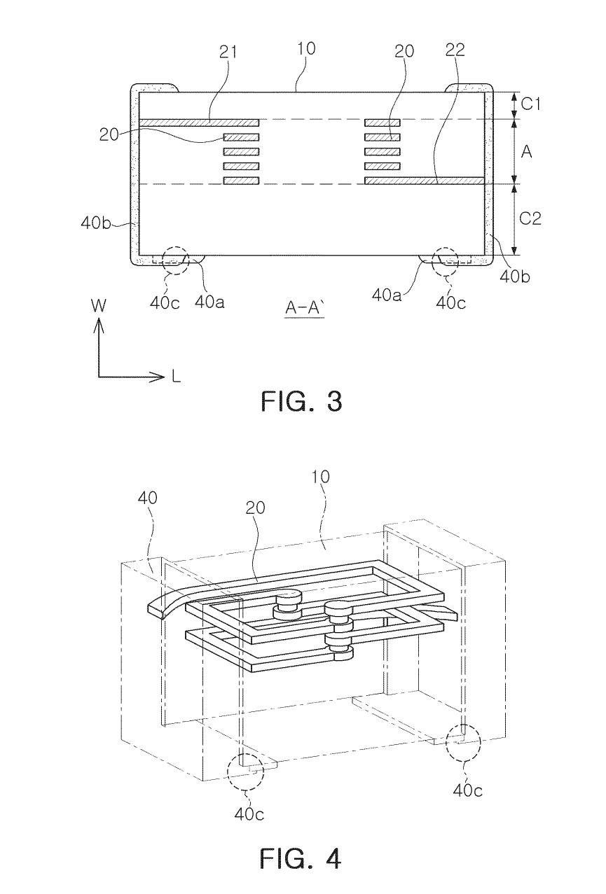

FIG. 3 is a cross-sectional view of the chip component shown in FIG. 1 taken along line A-A′.

FIG. 4 is a view showing internal electrodes in the chip component according to an exemplary embodiment of the present disclosure.

Referring to FIGS. 3 and 4, the internal electrodes 20 in the chip component according to the present disclosure may include first and second lead portions 21 and 22 exposed to both end surfaces of the multilayer body 10 and electrically connected to the second external electrodes 40b, respectively.

Meanwhile, the multilayer body 10 may include an active part A, which is a capacitance forming part, a first cover part C1 upwardly formed in the thickness direction of the multilayer body 10 of the active part A, and a second cover part C2 downwardly formed in the thickness direction of the active part A.

The first and second cover parts C1 and C2 may be formed by sintering the plurality of insulating layers 30, similar to the active part A. In addition, the plurality of insulating layers including the first and second cover parts C1 and C2, which are in a sintered state, maybe integrated with each other so that a boundary between the insulating layer and a dielectric layer adjacent to the insulating layer is not readily apparent without using a scanning electron microscope (SEM), similar to the active part A.

In the chip component according to an exemplary embodiment of the present disclosure, the first cover part C1 may be thinner than the second cover part C2.

In this case, a ratio of the thickness of the first cover part C1 and the thickness of the second cover part C2 may be 1:3.

That is, the internal electrodes 20 may be formed to be close to the top surface of the multilayer body 10, whereby the chip component may prevent deterioration of inductance L or Q characteristics by an eddy current.

More specifically, the chip component according to the present disclosure may be mounted on a printed circuit board (not shown) through the bottom surface provided as the mounting surface of the multilayer body 10.

In this case, in the chip component according to the related art, the eddy current may occur between the internal electrodes and the printed circuit board. This is a possible phenomenon of the printed circuit board itself due to reaction against a leakage current and may be regarded as a kind of law of inertia.

That is, this may correspond to resistance which is emerged to maintain a current state for itself and this influence may disturb the flow of magnetic flux, thereby deteriorating inductance L and Q characteristics of the chip component. Further, a frequency at which this phenomenon occurs may be increased as a distance between the internal electrodes and the printed circuit board is closer to each other.

Therefore, referring to FIGS. 3 and 4, in the chip component according to an exemplary embodiment of the present disclosure, the thickness of the second cover part C2 may be lager than the thickness of the first cover part C1 in order to significantly reduce the influence of the eddy current. That is, the internal electrodes 20 may be formed to be close to the top surface of the multilayer body 10.

Thereby, deterioration of inductance L and Q characteristics of the chip component according to an exemplary embodiment of the present disclosure may be prevented.

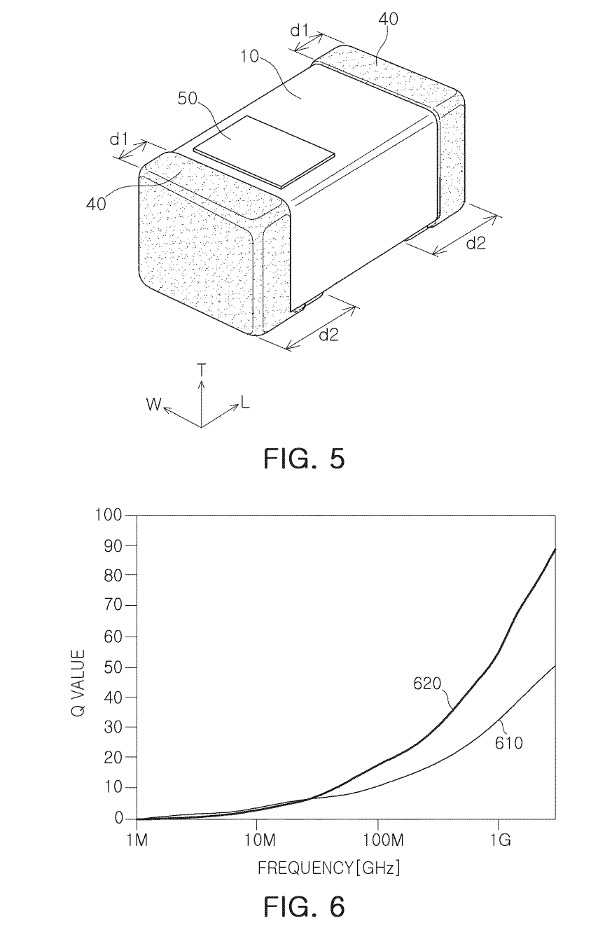

FIG. 5 is a perspective view showing a marking pattern in the chip component shown in FIG. 1.

Referring to FIG. 5, a width d1 of a portion of the external electrode 40 formed on the top surface of the multilayer body 10 in the length direction of the multilayer body 10 may be shorter than a width d2 of a portion of the external electrode 40 formed on the bottom surface of the multilayer body 10 in the length direction of the multilayer body 10.

As an example, the width d1 of the portion of the external electrode 40 formed on the top surface of the multilayer body 10 may be 50 μm and the width d2 of the portion of the external electrode 40 formed on the bottom surface of the multilayer body 10 may be 150 μm.

In the case in which the electronic components are highly integrated in response to miniaturization of an electronic product, problems such as a short-circuit occurrence, a malfunction of the electronic product, and the like may be caused by the contact between the external electrode formed on the top surface of the multilayer body 10 and a metal can covering an electronic component set.

However, in case of the chip component according to the present disclosure, by adjusting the width d1 of the portion of the external electrode 40 formed on the top surface of the multilayer body 10 to be shorter than the width d2 of the portion of the external electrode 40 formed on the bottom surface of the multilayer body 10, the problem such as the short-circuit occurrence, the malfunction of the electronic product, or the like when the external electrodes are in contact with the metal can may be significantly reduced.

Further, since the external electrodes 40 present on the top surface of the multilayer body 10 are significantly reduced, a problem such as space security, or the like may be solved and an effective area of the product may be increased. In addition, as the width d1 of the portion of the external electrode 40 formed on the top surface of the multilayer body 10 is relatively small, loss of magnetic flux may be reduced and Q characteristics may be improved.

Meanwhile, the width d2 of the portion of the external electrode 40 formed on the bottom surface of the multilayer body 10 may be designed to be larger than the width d1 in order to maintain a fixing strength.

That is, by adjusting the width d2 of the portion of the external electrode 40 formed on the bottom surface of the multilayer body 10 to be larger than the width d1 of the portion of the external electrode 40 formed on the top surface of the multilayer body 10, although the chip component according to an exemplary embodiment of the present disclosure is mounted on the printed circuit board, since the chip component does not topple over, reliability may be excellent and a short-circuit defect may be prevented.

The chip component according to an exemplary embodiment of the present disclosure may have a marking pattern 50 formed on one surface of the multilayer body 10 in order to identify surfaces to which the first and second lead portions 21 and 22 (FIG. 3) electrically connected to the second external electrodes 40b (FIG. 1) are exposed.

In this case, referring to FIG. 5, one surface of the multilayer body 10 on which the marking pattern 50 is formed may be the top surface of the multilayer body 10.

FIG. 6 is a comparison graph showing Q characteristics of the chip component according to an exemplary embodiment of the present disclosure.

Referring to FIG. 6, it may be appreciated that Q characteristics 620 of the chip component according to an exemplary embodiment of the present disclosure are higher than Q characteristics (610) of the chip component according to the related art.

The chip component according to the present disclosure may be formed in a structure in which the first cover part C1 is thinner than the second cover part C2. This means that the internal electrodes 20 may be formed to be close to the top surface of the multilayer body 10.

Therefore, since the chip component according to the present disclosure significantly reduces the influence of the eddy current, Q characteristics may be improved as compared to the chip component according to the related art.

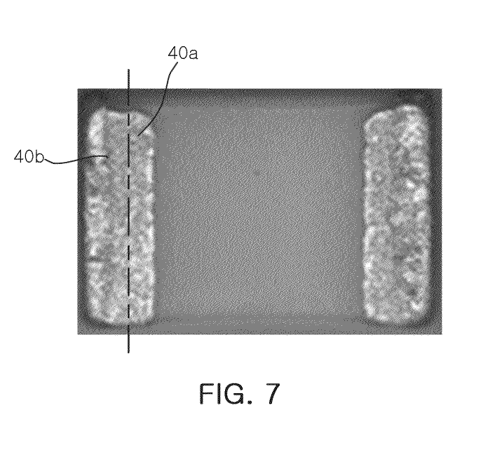

FIG. 7 is a view showing a bottom surface of the chip component according to an exemplary embodiment of the present disclosure.

Referring to FIG. 7, the second external electrodes 40b of the configurations of the chip component according to the present disclosure may be formed to cover at least portions of the first external electrodes 40a.

Therefore, the chip component according to the present disclosure may further include step portions 40c (FIG. 1) formed in regions in which the second external electrodes 40b cover at least portion of the first external electrodes 40a, on the bottom surface of the multilayer body 10.

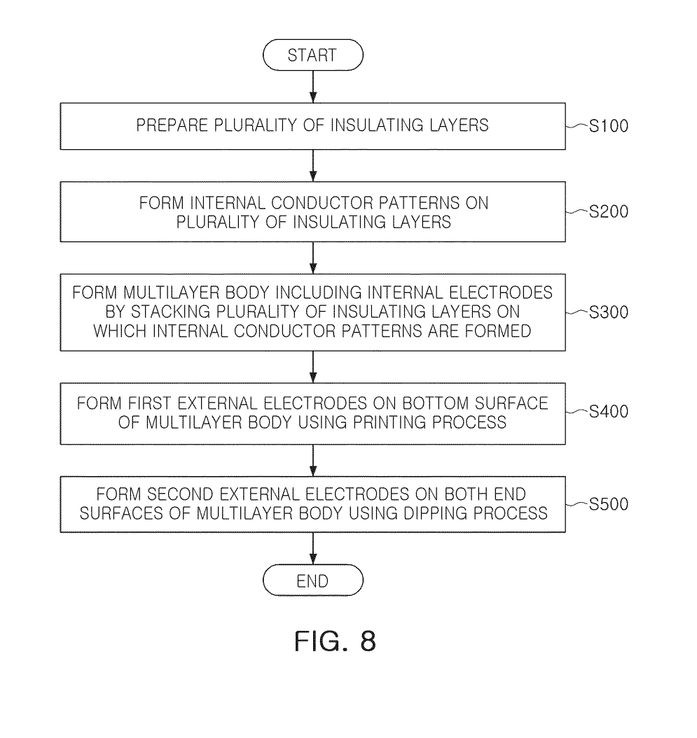

A method of forming the first and second external electrodes 40a and 40b will be described below with reference to FIG. 8.

### Manufacturing Method of Chip Component

FIG. 8 is a flowchart illustrating a method of manufacturing a chip component according to an exemplary embodiment of the present disclosure.

Referring to FIGS. 3 and 8, the manufacturing method of the chip component according to an exemplary embodiment of the present disclosure may include preparing a plurality of insulating layers (S100), forming internal conductor patterns on the plurality of insulating layers (S200), forming a multilayer body 10 having internal electrodes 20 (FIG. 3) which are formed by stacking the plurality of insulating layers on which the internal conductor patterns are formed (S300), forming first external electrodes 40a on a bottom surface of the multilayer body 10 using a printing process (S400), and forming second external electrodes 40b on both end surfaces of the multilayer body 10 in a length direction using a dipping process (S500).

More specifically, a magnetic body used to manufacture the plurality of insulating layers is not particularly limited, but may be a well-known ferrite powder such as a Mn—Zn-based ferrite powder, a Ni—Zn-based ferrite powder, a Ni—Zn—Cu-based ferrite powder, a Mn—Mg-based ferrite powder, a Ba-based ferrite powder, a Li-based ferrite powder, or the like.

A slurry formed by mixing the magnetic body and an organic material with each other may be applied on a carrier film and then dried to prepare the plurality of insulating layers.

Next, internal conductor patterns may be formed on the plurality of insulating layers. The internal conductor patterns may be formed by applying a conductive paste containing a conductive metal on the insulating layers by the printing process, or the like. As a printing method of the conductive paste, a screen printing method, a gravure printing method, or the like, may be used. However, the present disclosure is not limited thereto.

The conductive metal is not particularly limited as long as it is a metal having excellent electrical conductivity. For example, the conductive metal may be one of silver (Ag), palladium (Pd), aluminum (Al), nickel (Ni), titanium (Ti), gold (Au), copper (Cu), platinum (Pt), and the like, or a mixture thereof.

Next, the multilayer body 10 having the internal electrodes 20 in which first and second lead portions 21 and 22 (FIG. 3) are exposed to both end surfaces of the multilayer body in the length direction may be formed by stacking the plurality of insulating layers on which the internal conductor patterns are formed.

The respective insulating layers on which the internal conductor patterns are printed may have vias formed in predetermined positions and the internal conductor patterns formed on the respective insulating layers may be electrically connected to each other through the vias, thereby forming one coil.

The first lead portion 21 (FIG. 3) and the second lead portion 22 (FIG. 3) of the internal conductor patterns which are formed in one coil may be exposed to the same surface which is perpendicular to a stacked surface of the multilayer body 10.

Next, firstly, the first external electrode 40a may be formed on the bottom surface of the multilayer body 10 using the printing process (S400).

Next, secondarily, the second external electrode 40b may be formed on both end surfaces of the multilayer body 10 and the bottom surface thereof using the dipping process (S500). In this case, the second external electrodes 40b may be electrically connected to the first and second lead portions 21 and 22, respectively.

That is, the second external electrodes 40b may be formed to cover at least portions of the first external electrodes 40a which are pre-formed on the bottom surface of the multilayer body 10.

Further, the second external electrodes 40b may be formed to be extended from both end surfaces of the multilayer body 10 in the length direction thereof to the top surface of the multilayer body 10 or both side surfaces in the width direction thereof.

The first and second external electrodes 40a and 40b may be formed by using a conductive paste containing a metal having excellent electric conductivity. For example, the conductive paste may be a conductive paste containing one of nickel (Ni), copper (Cu), tin (Sn), silver (Ag), or the like, or an alloy thereof.

Further, the manufacturing method of the chip component according to an exemplary embodiment of the present disclosure may further include forming a marking pattern on the top surface of the multilayer body 10.

Other features overlapped with those of the above-mentioned chip component according to an exemplary embodiment of the present disclosure will be omitted.

As set forth above, according to exemplary embodiments of the present disclosure, the chip component and the manufacturing method thereof may prevent deterioration of inductance L or Q characteristics due to the eddy current. In addition, by adjusting the width of the portion of the external electrode formed on the bottom surface of the multilayer body to be larger than the width of the portion of the external electrode formed on the top surface of the multilayer body, the fixing strength may be improved.

While exemplary embodiments have been shown and described above, it will be apparent to those skilled in the art that modifications and variations could be made without departing from the scope of the present invention as defined by the appended claims.

What is claimed is:

1. A chip component comprising:
a multilayer body including a plurality of insulating layers and having a bottom surface provided as a mounting surface and a top surface opposing the bottom surface;
first external electrodes disposed on the bottom surface of the multilayer body; and
second external electrodes disposed on both end surfaces of the multilayer body in a length direction of the multilayer body and the bottom surface of the multilayer body,
wherein the second external electrodes are disposed to cover at least portions of the first external electrodes.

2. The chip component of claim 1, wherein the first external electrodes are printed on the bottom surface of the multilayer body.

3. The chip component of claim 1, wherein the second external electrodes are provided by dipping the end surfaces of the multilayer body into an electrode material.

4. The chip component of claim 1, further comprising internal electrodes having internal conductor patterns disposed on the plurality of insulating layers,
wherein the internal electrodes have a plurality of lead portions connected to the second external electrodes.

5. The chip component of claim 4, wherein the multilayer body includes:
an active part in which the internal electrodes are disposed;
a first cover part disposed between the top surface of the multilayer body and one surface of the active part; and
a second cover part disposed between the bottom surface of the multilayer body and the other surface of the active part opposing one surface of the active part, and
the second cover part is thicker than the first cover part.

6. The chip component of claim 1, wherein the second external electrodes are disposed to be extended from the end surfaces of the multilayer body to the top surface of the multilayer body.

7. A chip component comprising:
a multilayer body including a plurality of insulating layers and having a bottom surface provided as a mounting surface and a top surface opposing the bottom surface;
internal electrodes having internal conductor patterns disposed on the plurality of insulating layers;
first external electrodes disposed on the bottom surface of the multilayer body; and
second external electrodes disposed on both end surfaces of the multilayer body in a length direction of the multilayer body and the bottom surface of the multilayer body and connected to the internal electrodes; and
step portions formed by disposing the second external electrodes on at least portions of the first external electrodes.

8. The chip component of claim 7, wherein the step portions have a height of 10 to 30 μm.

9. The chip component of claim 7, wherein the first external electrodes are printed on the bottom surface of the multilayer body, and
the second external electrodes are provided by dipping the end surfaces of the multilayer body into an electrode material.

10. The chip component of claim 7, wherein the multilayer body includes:
an active part in which the internal electrodes are disposed;
a first cover part disposed between the top surface of the multilayer body and one surface of the active part; and
a second cover part disposed between the bottom surface of the multilayer body and the other surface of the active part opposing one surface of the active part, and
the second cover part is thicker than the first cover part.

11. The chip component of claim 7, wherein the second external electrodes are disposed to be extended from the end surfaces of the multilayer body to the top surface of the multilayer body.

12. A method of manufacturing a chip component, the method comprising:
preparing a plurality of insulating layers;
forming internal conductor patterns on the plurality of insulating layers;
forming a multilayer body including internal electrodes by stacking the plurality of insulating layers on which the internal conductor patterns are formed;
forming first external electrodes on a bottom surface of the multilayer body provided as a mounting surface of the multilayer body using a printing process; and
forming second external electrodes on both end surfaces of the multilayer body in a length direction of the multilayer body using a dipping process,
wherein the second external electrodes are disposed to cover at least portions of the first external electrodes.

13. The method of claim 12, further comprising forming a marking pattern on a top surface of the multilayer body opposing the bottom surface of the multilayer body.

14. The method of claim 12, wherein the multilayer body includes:
an active part in which the internal electrodes are disposed;
a first cover part disposed between a top surface of the multilayer body and one surface of the active part; and
a second cover part disposed between the bottom surface of the multilayer body and the other surface of the active part opposing one surface of the active part, and
the second cover part is thicker than the first cover part.
